(19) United States
(12) Patent Application Publication
(10) Pub. No.: US 2024/0412094 A1
(43) Pub. Date: Dec. 12, 2024

(54) TUNING HYPERPARAMETERS FOR POSTPROCESSING OUTPUT OF MACHINE LEARNING MODELS

(71) Applicant: Landing AI, Palo Alto, CA (US)

(72) Inventors: Jonathan Roncancio, Bogota (CO); Mark William Sabini, River Edge, NJ (US)

(21) Appl. No.: 18/206,452

(22) Filed: Jun. 6, 2023

(51) Int. Cl. G06N 20/00

(52) U.S. Cl. CPC G06N 20/00

(57) ABSTRACT

A system performs tuning of hyperparameters used for postprocessing of outputs of machine learning models. The system initializes a population of vectors representing values of postprocessing hyperparameters. The system repeatedly modifies the population by adding and removing members of the population. A fitness metric is used to identify vectors that are removed from the population. The system selects a vector from the population of vectors based on the fitness metric values and uses the values of postprocessing hyperparameters from the vector for postprocessing output of the machine learning model.

### FIELD OF ART

This disclosure relates in general to machine learning models, and in particular to tuning of hyperparameters of machine learning (ML) models.

### BACKGROUND

Artificial intelligence techniques such as machine learning models are often used for making predictions. Often further post processing is performed on the output of the machine learning models using hyperparameters. For example, thresholds may be applied to an output score of a machine learning model for classifying the input into a set of categories. Such hyperparameters are tuned to determine their optimal values. Such hyperparameters are not adjusted by the training of the machine learning models. As a result, tuning these hyperparameters can often be a tedious process. For example, the hyperparameter values can be determined by identifying all combinations of hyperparameters to select the optimal values of the hyperparameters. However, such a process is very computationally inefficient and may be intractable for large number of hyperparameters due to combinatorial explosion of the hyperparameter settings.

### SUMMARY

A system performs tuning of hyperparameters used for postprocessing of outputs of machine learning models. Values of postprocessing hyperparameters used for processing output score of the machine learning model are represented as vectors. The system initializes a population of vectors. The repeatedly modifies the population as follows. The system adds to the population, vectors generated from existing vectors of the population. The system determines a fitness metric value for each vector in the population by performing the following steps. The system provides an input data having a ground truth label as input the machine learning model and executes the machine learning model. The system processes the output score using the postprocessing hyperparameters represented by the vector to obtain a final output result. The system determines the fitness metric value based on the difference between the final output result and the ground truth label. The system removes one or more vectors from the population based on their fitness metric values. This process is repeated multiple times to modify the population of vectors. The system selects a vector from the population of vectors based on the fitness metric values and uses the values of postprocessing hyperparameters from the vector for postprocessing output of the machine learning model.

Embodiments include methods that perform the above steps, non-transitory computer-readable storage media that store instructions for performing the above methods, and computer systems that include processors and non-transitory computer-readable storage media storing instructions for performing the above methods.

### BRIEF DESCRIPTION OF DRAWINGS

FIG. 1 is a block diagram of a system environment for configuring and using a machine learning based model for making predictions, according to one embodiment.

FIG. 2 illustrates the system architecture of an online system for configuring and using a machine learning based model, according to one embodiment.

FIG. 3A illustrates a user mode for deploying an ML model according to an embodiment.

FIG. 3B illustrates a shadow mode for deploying an ML model according to an embodiment.

FIG. 3C illustrates a production mode for deploying an ML model according to an embodiment.

FIG. 4A shows the screen shot of the user interface of the visual inspection application in shadow mode, according to an embodiment.

FIG. 4B shows the screen shot of the user interface of the visual inspection application in production mode, according to an embodiment.

FIG. 5 shows the system architecture of the hyperparameter tuning module according to an embodiment.

FIG. 6 is a flow chart illustrating the overall process for determining values of postprocessing hyperparameters of a machine learning model, according to an embodiment.

FIG. 7 is a flow chart illustrating the process for determining fitness metric values for a set of postprocessing hyperparameters, according to an embodiment.

The figures depict various embodiments for purposes of illustration only. One skilled in the art will readily recognize from the following discussion that alternative embodiments of the structures and methods illustrated herein may be employed without departing from the principles of the embodiments described herein.

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is disclosed.

### DETAILED DESCRIPTION

A system uses user feedback on artificial intelligence (AI) solutions, for example, machine learning models for improving the AI solution. The system can be operated in various modes that allow model execution as well as user inspection to evaluate a machine learning model in various environments, for example, development environment or production environment. The system receives user feedback, thereby allowing users to inspect, intervene, override, and supervise the deployed AI solution. The model evaluation may be used for determining whether to promote the machine learning model in a continuous delivery process, for example, to determine whether a machine learning model can be promoted from a development environment to a production environment.

The system uses hyperparameters associated with the machine learning model. A hyperparameter represent values that are external to the machine learning model. The values of a hyperparameter do not change during learning/training of the machine learning model. Accordingly, hyperparameters of a machine learning model are distinct from the parameters of the machine learning model that get adjusted during training.

According to an embodiment, the system uses artificial intelligence techniques to tune hyperparameters such as postprocessing hyperparameters. The system uses techniques based on evolutionary computation techniques. For example, the system simultaneously tunes multiple class thresholds for an object detection model. The techniques disclosed herein can be applied to other types of postprocessing. The system finds close-to-optimal setting of post processing hyperparameters without iterating through all possible combinations. As a result, the techniques disclosed tune the hyperparameters of a machine learning model in a computationally efficient manner compared to existing techniques.

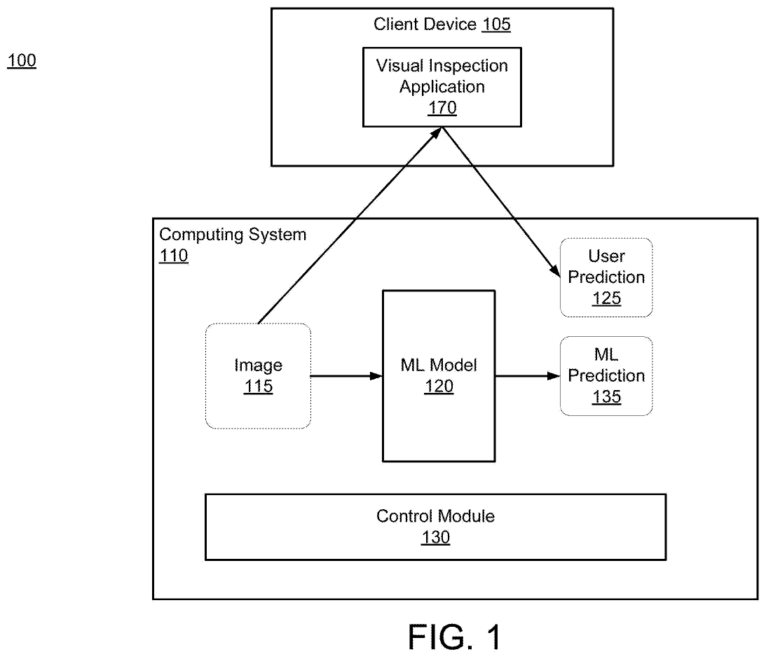

FIG. 1 is a block diagram of a system environment for configuring and using a machine learning based model for making predictions, according to one embodiment. The system environment 100 includes a computing system 110 and one or more client devices 105. The online system includes at least a ML model 120 and a control module 130.

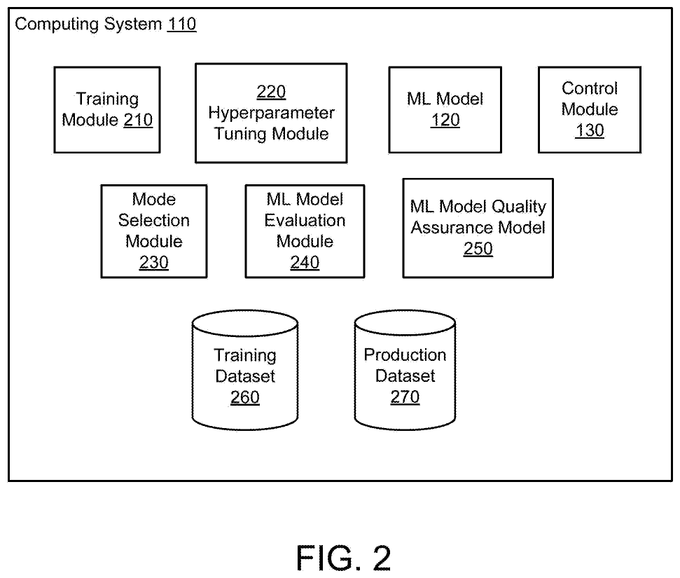

The computing system 110 may represent multiple computing systems even though illustrated as one block in FIG. 1. Accordingly, the modules shown in FIG. 1 and FIG. 2 may execute in one or more computing systems. A computing system 110 may be part of a cloud platform, for example, AWS (AMAZON Web Services), GCP (GOOGLE Cloud Platform), or AZURE cloud platform. Accordingly, one or more modules may execute in the cloud platform. Furthermore, multiple instances of a module may execute, for example, the ML model 120 may execute in a development environment as well as a production environment.

The ML model 120 is trained to predict a result by outputting a score. The computing system 110 may be used for machine learning applications that make decisions based on predictions of the machine learning model. The computing system 110 may perform postprocessing of the outputs generated by the ML model 120 using postprocessing hyperparameters. For example, the ML model 120 may be configured to receive an image 115 as input and trained to classify certain objects within the image. The postprocessing hyperparameters may represent threshold values used for classifying the object. According to an embodiment, the system may capture an image of an object and the ML model may make predictions re certain feature of the object.

The prediction made by the ML model is indicated as the ML prediction 135 in FIG. 1. For example, the system may capture images of a component in a manufacturing facility and the ML model is trained to predict whether the component is faulty. The manufacturing facility may use the predictions to make decisions regarding the component, for example, determine whether the component should be routed to a department for further inspection or the component may be routed for being delivered as a final product. The control module 130 generates control signals to perform these actions based on the predictions. For example, the control module 130 may either send a signal to be displayed via a user interface provided to an operator for taking appropriate action or the control module 130 may automatically operate equipment that routes the component as necessary based on the prediction.

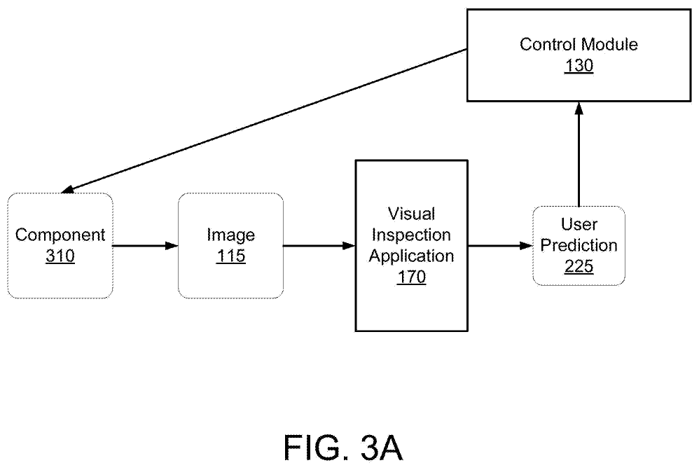

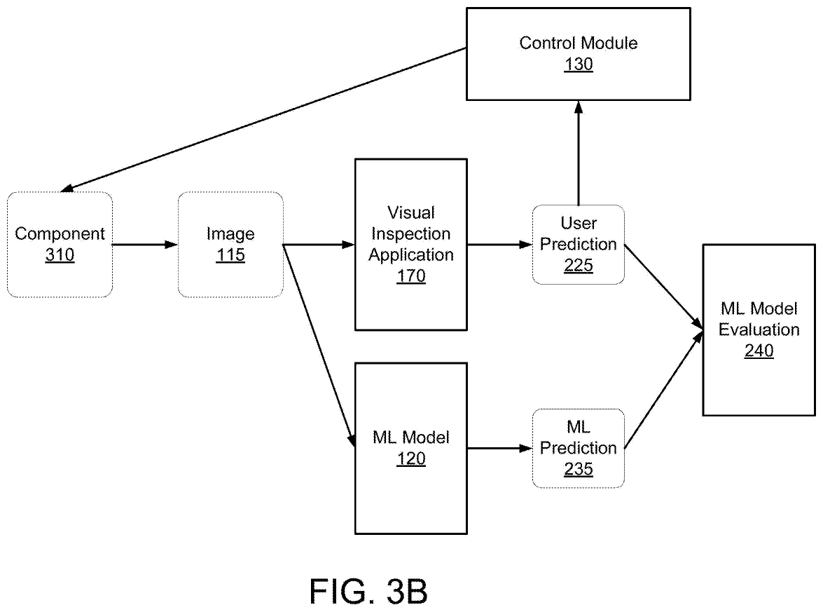

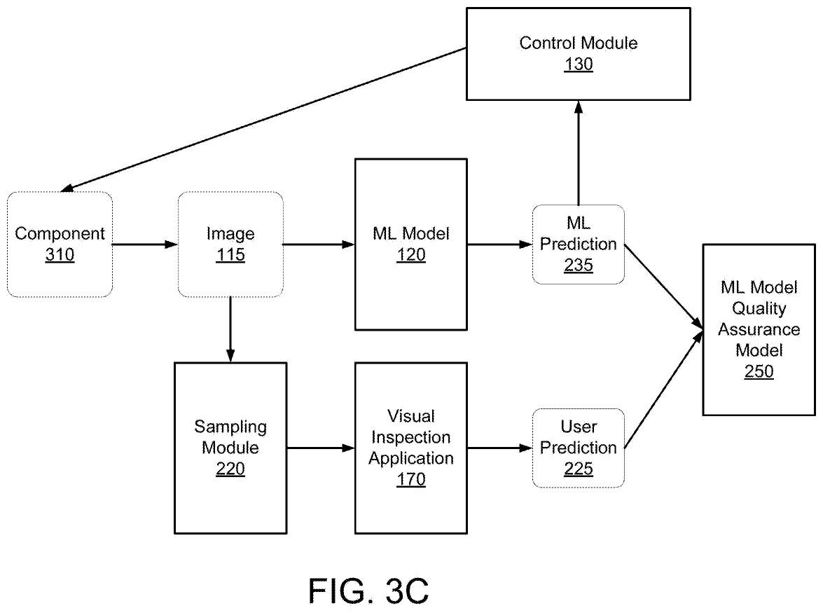

According to an embodiment, the image 115 is provided to a visual inspection application 170 displayed via the display of a client device 105. The visual application 170 allows a user, for example, an expert or an operator to provide feedback regarding the feature of the image being monitored. The user feedback is indicated as the user prediction 125 in FIG. 1. According to an embodiment, the feature determined by a user via visual inspection application 170 is the same feature regarding which a prediction is being made by the ML model 120. The computing system 110 uses the user prediction 125 and the ML prediction in various ways depending in the mode in which the computing system 110 is configured to operate. These modes are further described herein in connection with FIGS. 3A-C.

FIG. 2 illustrates the system architecture of an online system for configuring and using a machine learning based model, according to one embodiment. The computing system 110 includes a training module 210, a hyperparameter tuning module 220, the ML model 120, a mode selection module 230, an ML evaluation module 240, an ML quality assurance module 250, the control module 130, a training dataset 260, and a production dataset 270. Other embodiments may include more or fewer modules. Actions indicated as being performed by a particular module herein may be performed by other modules than those indicated. The ML model 120 and the control module 130 is described in connection with FIG. 1.

The training module 210 is used for training the ML model 120. The training dataset 260 is used for training the ML model 120. The training dataset may comprise labelled data where users, for example, experts view input data for the ML model and provide labels representing the expected output of the ML model for the input data. The training module 210 may initialize the parameters of the ML model using random values and use techniques such as gradient descent to modify the parameters, so as to minimize a loss function representing the difference between a predicted output and expected output for inputs of the training dataset.

In some embodiments, the training module 210 uses supervised machine learning to train the ML model 120. Different machine learning techniques—such as linear support vector machine (linear SVM), boosting for other algorithms (e.g., AdaBoost), neural networks, logistic regression, naïve Bayes, memory-based learning, random forests, bagged trees, decision trees, boosted trees, or boosted stumps—may be used in different embodiments. The training module 210 can periodically re-train the ML model 120 using features based on updated training data.

The production dataset 270 stores data collected from a production environment. For example, an ML model 120 may be trained using training dataset 260 and deployed in a production environment. The values predicted by the ML model 120 in the production environment are stored in the production dataset.

According to an embodiment, the system uses postprocessing hyperparameters that process the output predicted by the machine learning model. Postprocessing refers to operations performed on the outputs of the machine learning models, for example, filtering predictions, removing noise, applying thresholds, and so on. The system may use postprocessing hyperparameters, for example, threshold values for processing the outputs of the machine learning models. The postprocessed output of the machine learning model is used as the final result based on the machine learning model.

The hyperparameter tuning module 220 performs tuning of the postprocessing hyperparameters by maintaining an evolving population of values of the hyperparameters and using a fitness metric to evaluate the members of the population. The tuning of a postprocessing hyperparameter may depend on the use case. For example, the postprocessing hyperparameters may represent thresholds used for categorizing an output score into a plurality of classes. The threshold values corresponding to the postprocessing hyperparameter may be tuned differently for different applications. For example, the threshold values for an application A1 may be different from the threshold values for an application A2. A postprocessing hyperparameter may be a maximum size of a contour to filter out noise. The value of such a postprocessing hyperparameter depends on the application since different applications may use different maximum sizes of contours to filter out noise. According to an embodiment, the system adds new data back to the training set, for example, data obtained from a production environment, and the system readjusts (i.e., tunes again) the postprocessing hyperparameters.

The data presented to the user includes the input processed by the ML model and the results as predicted by the ML model via the visual inspection application 170. The user can provide feedback regarding the prediction of the ML model. Accordingly, the user can indicate whether the prediction of the ML model 120 is accurate or poor. This feedback is used by the ML quality assurance module 250 for testing the quality of the ML model in production environment. Similar process may be used in a development or staging environment for evaluating the ML model by the ML evaluation module 240. According to an embodiment, the ML evaluation module 240 determines metrics such as precision, recall, and accuracy of the ML model 120 based on production data to evaluate the ML model.

FIGS. 3A-C illustrate various modes in which the computing system 110 can operate for deploying an ML model. These modes may be used for example, in a manufacturing facility for controlling workflow related to some components 310. An image 115 of the component 310 is captured and is used to determine what action to take for the component based on either visual inspection or ML model or both.

FIG. 3A illustrates a user mode for deploying an ML model according to an embodiment. In the user mode, the prediction of the value of a feature of the component 310 is made by a user via visual inspection. The control module uses the user predictions to make determinations re the actions taken with respect to the component 310.

In this mode, the image 115 of the component 310 is sent by the computing system 110 to a visual inspection application 170 running on the client device 105. A user makes a determination regarding a specific feature of the component, for example, whether the component is defective. The determination by the user is referred to as the user prediction 225. The user prediction 225 is provided to the control module 130. The control module 130 generates the signals necessary to take the appropriate action associated with the component based on the user prediction 225. For example, a particular action A1 may be taken if the user prediction 225 indicates a particular value of the feature (e.g., feature indicating that the component is faulty), and a different action A2 may be taken if the user prediction 225 indicates a different value of the feature (e.g., feature indicating that the component is not faulty).

FIG. 3B illustrates a shadow mode for deploying an ML model according to an embodiment. In the shadow mode, the prediction of the value of the feature is made by a user via visual inspection. However, a prediction is also made by the ML model. The control module uses the user predictions to make determinations re the actions taken with respect to the component 310. The two predictions can be compared to evaluate the ML model and see how it is likely to perform in production without actually using the predictions of the ML model for making decisions re the components.

As shown in FIG. 3B, the image 115 of the component is provided as input to both the visual inspection application 170 and the ML model 120. The user views the visual inspection application 170 and make the user prediction 225 of the value of the feature of the component. The ML model 120 makes the ML prediction 235 of the value of the feature of the component. The user predictions are provided to the control module to control module 130 and the control module 130 generates the signals necessary to take the appropriate action associated with the component based on the user prediction 225. The ML prediction 235 is used to evaluate the ML model 120, for example, to measure the performance of the ML model when processing input data obtained in production. The evaluation may be performed by ML evaluation module 240. The system may store the ML predictions 235 obtained by execution of the ML model and the user prediction 225 in logs for processing at a later stage.

FIG. 3C illustrates a production mode for deploying an ML model according to an embodiment. In production mode, the image obtained from a component is processed both by the ML model 120 and by a user performing visual inspection. However, control module uses the ML predictions to make determinations re the actions taken with respect to the component 310.

As shown in FIG. 3C, the image 115 of the component is provided as input to both the visual inspection application 170 and the ML model 120. The ML model 120 makes the ML prediction 235 of the value of the feature of the component. The ML predictions 235 are provided to the control module to control module 130 and the control module 130 generates the signals necessary to take the appropriate action associated with the component based on the ML prediction 235. The user also views the visual inspection application 170 and make the user prediction 225 of the value of the feature of the component.

According to an embodiment, not all data values obtained in production are provided to the visual inspection application 170. The system may store the user predictions 225 provided by the user and also the ML predictions 235 obtained by execution of the ML model in logs for processing at a later stage. The user prediction 225 is used for quality assurance purposes. For example, the ML Model quality assurance module 250 may process the logs to determine how the ML model 120 performed in production environment. If the ML model 120 performs poorly in certain contexts, the information may be provided, for example, to developers or testers to further evaluate the ML model. For example, a determination by the ML quality assurance module 250 that the ML model performs poorly for certain type of inputs may be used for obtaining training data based on that particular type of inputs and using for retraining the ML model 120.

The system may operate in other modes not described in FIGS. 3A-C, for example, an experimental mode in which the ML model is used for processing all the inputs and the visual inspection application is not used. This mode may be used during development and testing of the ML model 120.

The different modes of the system illustrated herein are used in a CI/CD pipeline for deploying ML models, for example, in a cloud platform. For example, an experimental mode may be used for building the ML model in a development environment. While the ML model is being developed, the production environment is handled using the user mode. When the ML model passes the criteria for being promoted to the next stage, for example, staging environment, the shadow mode may be used for evaluating the ML model 120. When the ML model 120 is evaluated to determine that the ML model satisfies the required quality metrics for being promoted to a production stage, the system operates in the production mode.

According to an embodiment, the computing system 110 reconfigures the user interface of the visual inspection application 170 based on the mode of the system which in turn is determined based on the type of environment that the system is operating in. The automatic reconfiguration of the visual inspection application allows the system to automate a continuous integration/continuous deployment pipeline being executed for deployment of the ML models, for example, in cloud platforms.

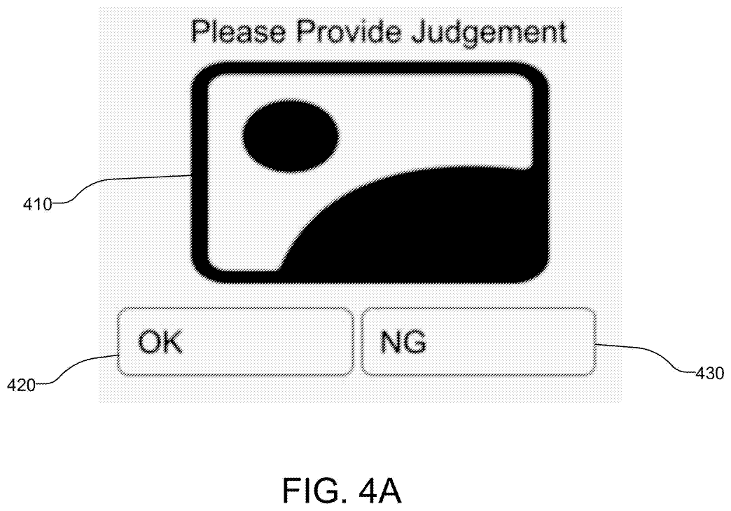

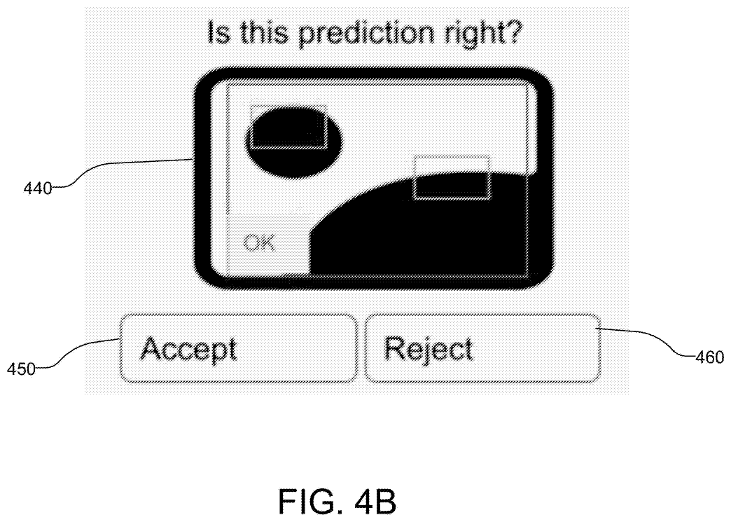

FIGS. 4A-B show screen shots of the user interface used for performing visual inspection according to an embodiment. FIG. 4A shows the screen shot of the user interface of the visual inspection application in shadow mode, according to an embodiment. The user interface presents an image 410 being processed to the user, for example, an image of a component in a manufacturing facility. The user is provided with buttons or any other widget for providing input for example, drop down lists, text boxes, and so on. For example, button 420 allows user to indicate that the component displayed in the image 410 is good (i.e., OK) and button 430 allows the user to indicate that the component displayed in the image is not good (i.e., NG).

FIG. 4B shows the screen shot of the user interface of the visual inspection application in production mode, according to an embodiment. The image 440 presented to the user includes the result of the processing performed by the ML model 120. Widgets 450, 460 are provided to the user to provide inputs indicating whether the user accepts or rejects the prediction of the ML model respectively.

### Hyperparameter Tuning

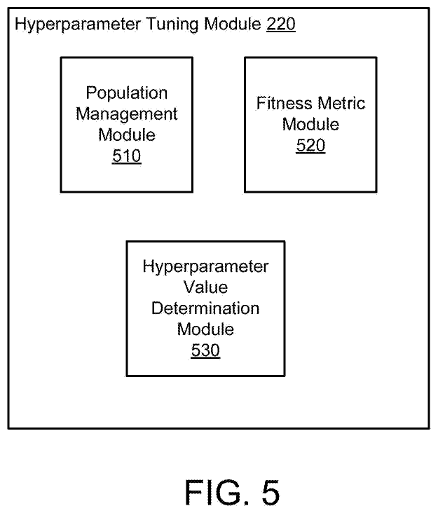

FIG. 5 shows the system architecture of the hyperparameter tuning module 220 according to an embodiment. The hyperparameter tuning module 220 includes a population management module 510, a fitness metric module 520, and a hyperparameter value determination module 530. Other embodiments may have more or fewer modules than those indicated in FIG. 5.

The population management module 510 maintains a population of members, each member representing a set of values of hyperparameters. For example, if the system uses a plurality of postprocessing hyperparameters, the system may represent each set of values of the postprocessing hyperparameters using a vector. Accordingly, the population management module 510 maintains a population of vectors, each vector representing a set of values of the postprocessing hyperparameters. The population management module 510 modifies the population by adding new members or by removing existing members. The The fitness metric module 520 determines a value of a fitness metric for each member of the population. The fitness metric provides an indication of the quality of the member. For example, assume that a member M1 has a fitness metric value F1 and a member M2 has a fitness metric value F2. If fitness metric value F1 indicates better fitness than fitness metric value F2 then member M1 provides better performance compared to member M2. For example, if each member represents values of postprocessing hyperparameters, member M1 provides better performance compared to member M2 if postprocessing of the output of the machine learning model performed using M1 provides more accurate results than postprocessing of the output of the machine learning model performed using M2.

The hyperparameter value determination module 530 executes the process that determined values of the hyperparameters using an evolving population of members. The process for determining postprocessing hyperparameters is described next.

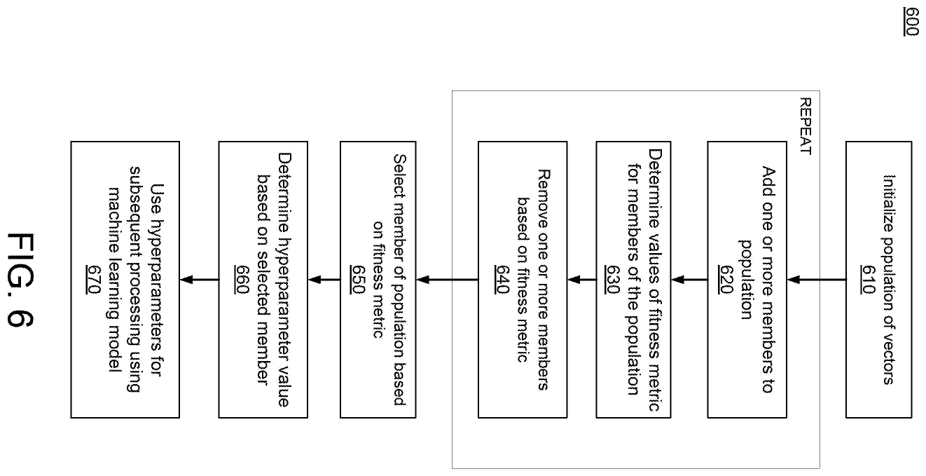

FIG. 6 is a flow chart illustrating the overall process for determining values of postprocessing hyperparameters of a machine learning model, according to an embodiment. The steps of the process may be executed in an order different from that indicated herein. The steps are indicated as executed by a system, for example, the computing system 110 and may be executed by modules indicated in FIG. 1, 2, or 5.

In the following description, each set of values of postprocessing hyperparameters is represented as a vector. However, values of postprocessing hyperparameters may be represented using other types of representation, for example, as key value pairs. The system initializes 610 a population of vectors. Each vector represents values of postprocessing hyperparameters for processing output score of the machine learning model. The system may initialize each set of postprocessing hyperparameters randomly.

The system repeats the steps 620, 630, 640 a plurality of times. The system adds 620 one or more vectors to the population of vectors. The new vectors that are added are generated from existing vectors of the population. For example, the system may make a copy of an existing vector and modify one or more elements of the vector. The system may modify the value of an element of the vector by scaling it by a factor. The system may generate a vector by combining two vectors. For example, the system may select vectors V1 and V2 and generate vectors V3 and V4 by swapping one or more corresponding elements of the vectors V1 and V2. The system may obtain a vector by selectively taking some elements from vector V1 and some elements from vector V2.

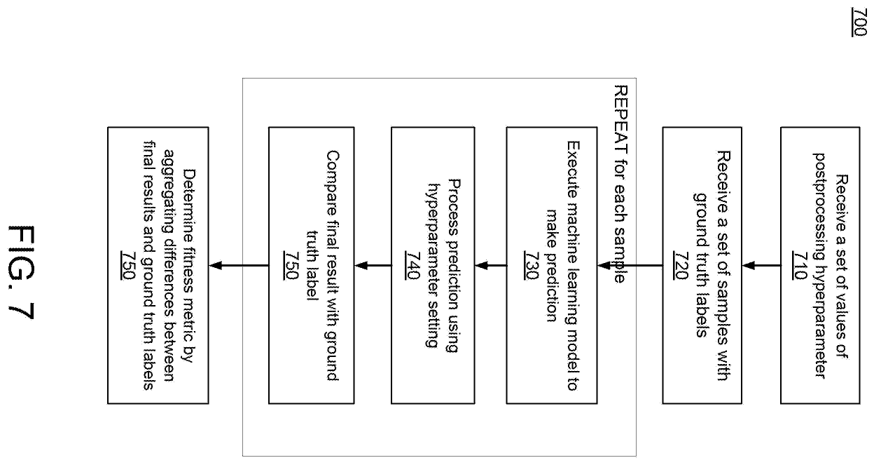

The system determines 630 a fitness metric value for each vector from the population of vectors. The process of determining the fitness metric is illustrated in FIG. 7 and described in connection with FIG. 7.

The system removes 640 one or more vectors from the population based on fitness metric values of the one or more vectors. For example, the system may identify vectors having fitness metric values indicating the lowest fitness and remove them from the population.

The system selects 650 a vector from the population of vectors based on the fitness metric values. For example, the system may select the vector from the population of vectors that has a fitness metric value indicating highest fitness in the population compared to other vectors. The system determines 650 the postprocessing hyperparameter values based on the selected vector. For example, the system may extract values from the selected vectors and assign the values to corresponding postprocessing hyperparameters.

The system uses the determined values of postprocessing hyperparameters for postprocessing of output of the machine learning model. For example, the postprocessing hyperparameters may be used for postprocessing outputs of machine learning models deployed in a production environment.

FIG. 7 is a flow chart illustrating the process for determining fitness metric values for a set of postprocessing hyperparameters, according to an embodiment. The steps indicated in the flowchart may be performed in an order different from that indicated herein. The steps are indicated as executed by a system, for example, the computing system 110 and may be executed by modules indicated in FIG. 1, 2, or 5.

The system receives 710 a set of values of postprocessing hyperparameters. The set of values may be obtained from a population of vectors being processed by the process illustrated in FIG. 6. The system receives a set of samples with ground truth labels. For example, the samples may be obtained from a labelled training dataset.

The system repeats the steps 730, 740, 750 for each sample of the set of samples. The system executes 730 the machine learning model for an input data represented by the sample to obtain an output score. The input data represented by the sample is associated with a ground truth label. The system processes 740 the output score using postprocessing hyperparameters represented by the vector to obtain a final output result. The system determines 750 the fitness metric value by comparing the final output result and the ground truth label, for example, the fitness metric value is determined based on a difference between the final output result and the ground truth label. According to an embodiment, the system uses a distance metric between the final output result and the ground truth label as the fitness metric value for the sample. Note that this process is distinct from the process of adjusting the parameters of the machine learning model using gradient descent. The system uses the fitness metric for evaluating the different members of the population. The hyperparameters are modified by the step 620 that modifies the population which is distinct from the process of gradient descent.

The system determines the fitness metric values for the postprocessing hyperparameters by aggregating the fitness metric values for the samples. For example, the fitness metric values for the postprocessing hyperparameters may be an average, a median, a mode or any other aggregate measure of the fitness metric values for the set of samples.

### ADDITIONAL CONFIGURATION CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code or instructions embodied on a non-transitory computer readable storage medium or machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process based on the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined herein.

What is claimed is:

1. A computer-implemented method for tuning postprocessing hyperparameters of a machine learning model, the computer-implemented method comprising:
initializing a population of vectors, each vector representing values of postprocessing hyperparameters for processing output score of the machine learning model;
repeating a plurality of times:
adding one or more vectors to the population of vectors, the one or more vectors generated from existing vectors of the population;
determining a fitness metric value for each of the population of vectors, comprising:
executing the machine learning model for an input data to obtain an output score, the input data associated with a ground truth label;
processing the output score using postprocessing hyperparameters represented by the vector to obtain a final output result; and
determining the fitness metric value based on a difference between the final output result and the ground truth label;
removing one or more vectors from the population based on fitness metric values of the one or more vectors;
selecting a vector from the population of vectors based on the fitness metric values; and
using values of postprocessing hyperparameters from the vector selected for postprocessing of output of the machine learning model.

2. The computer-implemented method of claim 1, wherein the machine learning model classifies an input data to one of a plurality of categories, wherein the output score of the machine learning model is mapped to a category based on a plurality of thresholds, each threshold representing a postprocessing hyperparameter.

3. The computer-implemented method of claim 2, wherein each vector of the population of vectors represents a plurality of values, each value corresponding to a threshold from the plurality of thresholds.

4. The computer-implemented method of claim 1, wherein the fitness metric value is determined as an aggregate measure of difference between each final output result and corresponding ground truth label for a plurality of samples, each sample representing an input data with a ground truth label.

5. The computer-implemented method of claim 1, wherein generating one or more vectors from existing vectors of the population comprises, identifying a vector from the population of vectors and modifying one or more elements of the vector to obtain a new vector.

6. The computer-implemented method of claim 1, wherein generating one or more vectors from existing vectors of the population comprises, identifying a first vector and a second vector from the population of vectors and swapping an element of the first vector with corresponding element of the second vector to obtain a modified first vector and a modified second vector.

7. The computer-implemented method of claim 1, wherein a postprocessing hyperparameter represents size of a contour for filtering out noise from the output of the machine learning model.

8. A non-transitory computer readable storage medium storing instructions that when executed by one or more computer processors, cause the one or more computer processors to perform steps for tuning postprocessing hyperparameters of a machine learning model, the steps comprising:
initializing a population of vectors, each vector representing values of postprocessing hyperparameters for processing output score of the machine learning model;
repeating a plurality of times:
adding one or more vectors to the population of vectors, the one or more vectors generated from existing vectors of the population;
determining a fitness metric value for each of the population of vectors, comprising:
executing the machine learning model for an input data to obtain an output score, the input data associated with a ground truth label;
processing the output score using postprocessing hyperparameters represented by the vector to obtain a final output result; and
determining the fitness metric value based on a difference between the final output result and the ground truth label;
removing one or more vectors from the population based on fitness metric values of the one or more vectors;
selecting a vector from the population of vectors based on the fitness metric values; and
using values of postprocessing hyperparameters from the vector selected for postprocessing of output of the machine learning model.

9. The non-transitory computer readable storage medium of claim 8, wherein the machine learning model classifies an input data to one of a plurality of categories, wherein the output score of the machine learning model is mapped to a category based on a plurality of thresholds, each threshold representing a postprocessing hyperparameter.

10. The non-transitory computer readable storage medium of claim 9, wherein each vector of the population of vectors represents a plurality of values, each value corresponding to a threshold from the plurality of thresholds.

11. The non-transitory computer readable storage medium of claim 8, wherein the fitness metric value is determined as an aggregate measure of difference between each final output result and corresponding ground truth label for a plurality of samples, each sample representing an input data with a ground truth label.

12. The non-transitory computer readable storage medium of claim 8, wherein generating one or more vectors from existing vectors of the population comprises, identifying a vector from the population of vectors and modifying one or more elements of the vector to obtain a new vector.

13. The non-transitory computer readable storage medium of claim 8, wherein generating one or more vectors from existing vectors of the population comprises, identifying a first vector and a second vector from the population of vectors and swapping an element of the first vector with corresponding element of the second vector to obtain a modified first vector and a modified second vector.

14. The non-transitory computer readable storage medium of claim 8, wherein a postprocessing hyperparameter represents size of a contour for filtering out noise from the output of the machine learning model.

15. A computer system comprising:
one or more computer processors; and
a non-transitory computer readable storage medium storing instructions that when executed by one or more computer processors, cause the one or more computer processors to perform steps for tuning postprocessing hyperparameters of a machine learning model, the steps comprising:
initializing a population of vectors, each vector representing values of postprocessing hyperparameters for processing output score of the machine learning model;
repeating a plurality of times:
adding one or more vectors to the population of vectors, the one or more vectors generated from existing vectors of the population;
determining a fitness metric value for each of the population of vectors, comprising:
executing the machine learning model for an input data to obtain an output score, the input data associated with a ground truth label;
processing the output score using postprocessing hyperparameters represented by the vector to obtain a final output result; and
determining the fitness metric value based on a difference between the final output result and the ground truth label;
removing one or more vectors from the population based on fitness metric values of the one or more vectors;
selecting a vector from the population of vectors based on the fitness metric values; and
using values of postprocessing hyperparameters from the vector selected for postprocessing of output of the machine learning model.

16. The computer system of claim 15, wherein the machine learning model classifies an input data to one of a plurality of categories, wherein the output score of the machine learning model is mapped to a category based on a plurality of thresholds, each threshold representing a postprocessing hyperparameter.

17. The computer system of claim 16, wherein each vector of the population of vectors represents a plurality of values, each value corresponding to a threshold from the plurality of thresholds.

18. The computer system of claim 15, wherein the fitness metric value is determined as an aggregate measure of difference between each final output result and corresponding ground truth label for a plurality of samples, each sample representing an input data with a ground truth label.

19. The computer system of claim 15, wherein generating one or more vectors from existing vectors of the population comprises, identifying a vector from the population of vectors and modifying one or more elements of the vector to obtain a new vector.

20. The computer system of claim 15, wherein generating one or more vectors from existing vectors of the population comprises, identifying a first vector and a second vector from the population of vectors and swapping an element of the first vector with corresponding element of the second vector to obtain a modified first vector and a modified second vector.
